(19) United States
(12) Patent Application Publication
(10) Pub. No.: US 2013/0007376 A1
(43) Pub. Date: Jan. 3, 2013

(54) OPPORTUNISTIC SNOOP BROADCAST (OSB) IN DIRECTORY ENABLED HOME SNOOPY SYSTEMS

(76) Inventors: SAILESH KOTTAPALLI, San Jose, CA (US); VEDARAMAN GEETHA, Fremont, CA (US); HENK G. NEEFS, Palo Alto, CA (US); YOUNGSOO CHOI, Alameda, CA (US)

(21) Appl. No.: 13/175,787

(22) Filed: Jul. 1, 2011

(51) Int. Cl. G06F 12/08

(52) U.S. Cl. 711/146; 711/E12.033

(57) ABSTRACT

Methods and apparatus relating to Opportunistic Snoop Broadcast (OSB) in directory enabled home snoopy systems are described. In one embodiment, a plurality of snoops are broadcast to a plurality of caching agents in response to a request for data and based on a comparison of a bandwidth consumption of the link and a threshold value. Other embodiments are also disclosed.

### FIELD

The present disclosure generally relates to the field of electronics. More particularly, an embodiment of the invention relates to Opportunistic Snoop Broadcast (OSB) in directory enabled home snoopy systems.

### BACKGROUND

Cache memory in computer systems may be kept coherent using a snoopy bus or a directory based protocol. In either case, a memory address is associated with a particular location in the system. This location is generally referred to as the “home node” of a memory address.

In a directory based protocol, processing/caching agents may send requests to a home node for access to a memory address with which a corresponding Home Agent (HA) is associated. Accordingly, performance of such computer systems may be directly dependent on how efficiently home agent data and/or memory is managed.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1-2 and 6-7 illustrate block diagrams of embodiments of computing systems, which may be utilized to implement various embodiments discussed herein.

FIGS. 3-5 illustrate flow diagrams according to some embodiments.

### DETAILED DESCRIPTION

In the following description, numerous specific details are set forth in order to provide a thorough understanding of various embodiments. However, some embodiments may be practiced without the specific details. In other instances, well-known methods, procedures, components, and circuits have not been described in detail so as not to obscure the particular embodiments.

Some embodiments reduce latency and/or increase bandwidth in a directory based cache coherence system in a scalable manner. Moreover, microprocessor performance may be improved by reducing cache-to-cache transfer latency and/or improving application memory bandwidth. For example, one embodiment opportunistically broadcasts snoops to reduce load-to-use-latency by initiating the cache-to-cache transfer of data early when the coherence interconnect bandwidth usage is determined to be low (e.g., based on threshold and/or count values, per transaction type(s) in some embodiments). Additionally, an embodiment allows for trade-off between coherency bandwidth (e.g., snoops and responses) versus memory bandwidth, such as for requests requiring pure ownership and not data, in a scalable manner; thus, increasing application memory bandwidth. Another embodiment provides an early data return technique where data may be returned based on directory information and before all opportunistic snoop responses arrive. Additionally, an embodiment provides a technique for trading off performance (latency and/or memory bandwidth) versus power efficiency. Also, some caching agents or cache lines may not be under directory control and requests from caching agents not under directory control and invoking opportunistic snoop broadcast, do not need to read the memory directory at all in an embodiment.

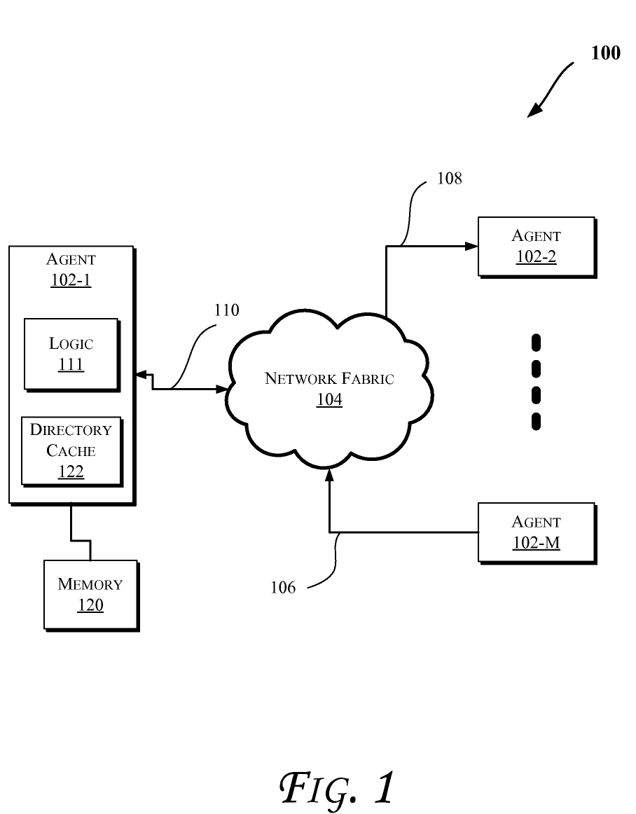

Generally, cache memory in computing systems may be kept coherent using a snoopy bus or a directory based protocol. In either case, a system memory address may be associated with a particular location in the system. This location is generally referred to as the “home node” of the memory address. In a directory based protocol, processing/caching agents may send requests to the home node for access to a memory address with which a “home agent” (or HA) is associated. Moreover, in distributed cache coherence protocols, caching agents (CAs) may send requests to home agents which control coherent access to corresponding memory spaces (e.g., a subset of the memory space is served by the collocated memory controller). Home agents are, in turn, responsible for ensuring that the most recent copy of the requested data is returned to the requestor either from memory or a caching agent which owns the requested data. The home agent may also be responsible for invalidating copies of data at other caching agents if the request is for an exclusive copy, for example. For these purposes, a home agent generally may snoop every caching agent or rely on a directory (e.g., directory cache 122 of FIG. 1 or a copy of a memory directory stored in a memory, such as memory 120 of FIG. 1) to track one or more caching agents where the data may reside. In an embodiment, the directory cache 122 may include a full or partial copy of the directory stored in the memory 120.

Moreover, snooping every caching agent for every read request may have latency advantage in some cases. For example, if the most recent data is present in another caching agent, it will be returned much faster to the requestor. However, this approach may have the disadvantage of increasing interconnect bandwidth usage and power. In fact, in large scalable systems, under some application loads, the interconnect bandwidth usage could increase to the extent that it could become saturated and reduce the entire system performance. In a directory mode, the directory information may be read from memory first to determine if snooping of caching agents is needed from the home agent. This sequence minimizes the required interconnect bandwidth usage and power, and may be used for building large scalable systems. However, this approach has a latency disadvantage if the most recent data is present in a different caching agent.

System design point choices (for interconnect bandwidths and latency optimizations), system topology, as well as coherence interconnect loading and memory interconnect loading, might lead to the snoop response return latency being longer than the memory latency or vice versa. Many factors, some of them dynamic, may play a role here. So it is not always unambiguously predictable what solution (always snoop or directory based) results in the lowest latency.

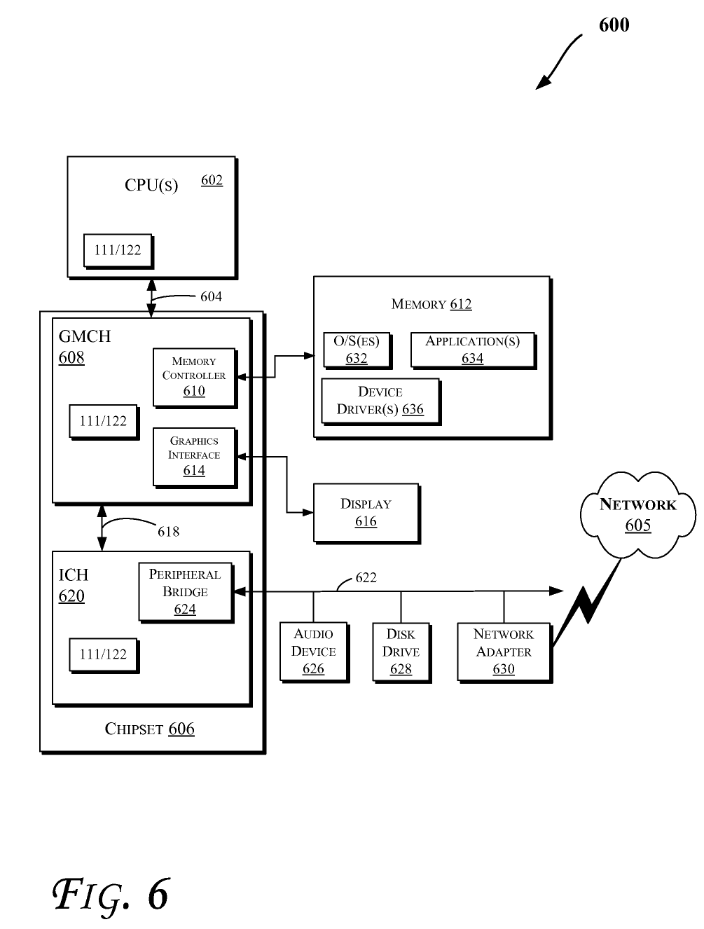

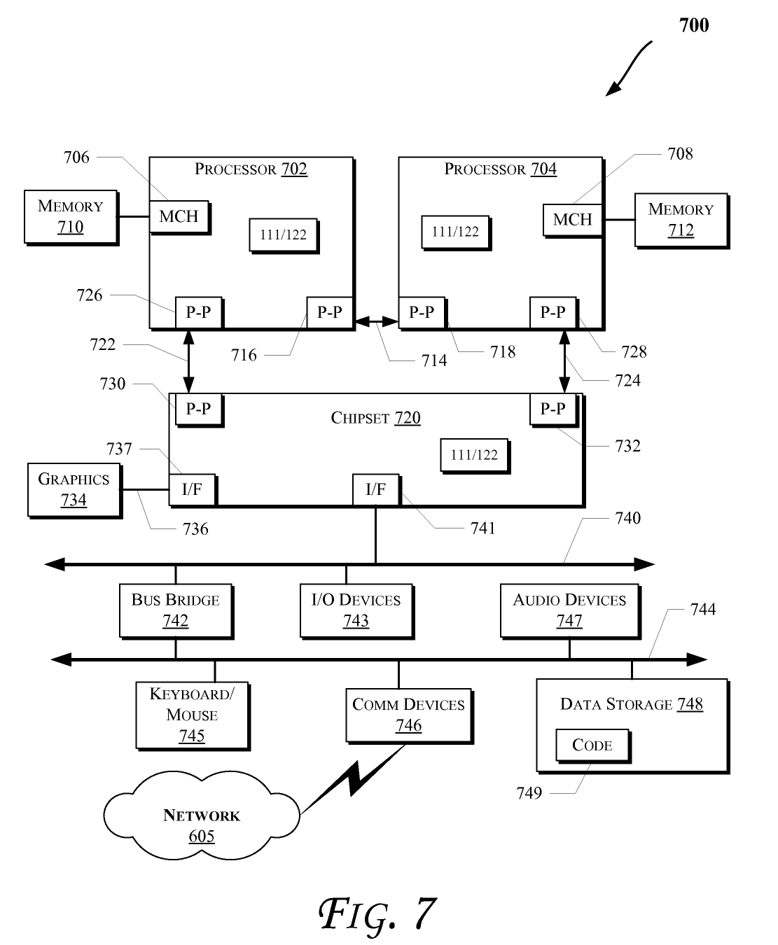

Various computing systems may be used to implement embodiments, discussed herein, such as the systems discussed with reference to FIGS. 1 and 6-7. More particularly, FIG. 1 illustrates a block diagram of a computing system 100, according to an embodiment of the invention. The system 100 may include one or more agents 102-1 through 102-M (collectively referred to herein as “agents 102” or more generally “agent 102”). In an embodiment, one or more of the agents 102 may be any of components of a computing system, such as the computing systems discussed with reference to FIGS. 6-7.

As illustrated in FIG. 1, the agents 102 may communicate via a network fabric 104. In one embodiment, the network fabric 104 may include a computer network that allows various agents (such as computing devices) to communicate data. In an embodiment, the network fabric 104 may include one or more interconnects (or interconnection networks) that communicate via a serial (e.g., point-to-point) link and/or a shared communication network (which may be configured as a ring in an embodiment). For example, some embodiments may facilitate component debug or validation on links that allow communication with Fully Buffered Dual in-line memory modules (FBD), e.g., where the FBD link is a serial link for coupling memory modules to a host controller device (such as a processor or memory hub). Debug information may be transmitted from the FBD channel host such that the debug information may be observed along the channel by channel traffic trace capture tools (such as one or more logic analyzers).

In one embodiment, the system 100 may support a layered protocol scheme, which may include a physical layer, a link layer, a routing layer, a transport layer, and/or a protocol layer. The fabric 104 may further facilitate transmission of data (e.g., in form of packets) from one protocol (e.g., caching processor or caching aware memory controller) to another protocol for a point-to-point or shared network. Also, in some embodiments, the network fabric 104 may provide communication that adheres to one or more cache coherent protocols.

Furthermore, as shown by the direction of arrows in FIG. 1, the agents 102 may transmit and/or receive data via the network fabric 104. Hence, some agents may utilize a unidirectional link while others may utilize a bidirectional link for communication. For instance, one or more agents (such as agent 102-M) may transmit data (e.g., via a unidirectional link 106), other agent(s) (such as agent 102-2) may receive data (e.g., via a unidirectional link 108), while some agent(s) (such as agent 102-1) may both transmit and receive data (e.g., via a bidirectional link 110).

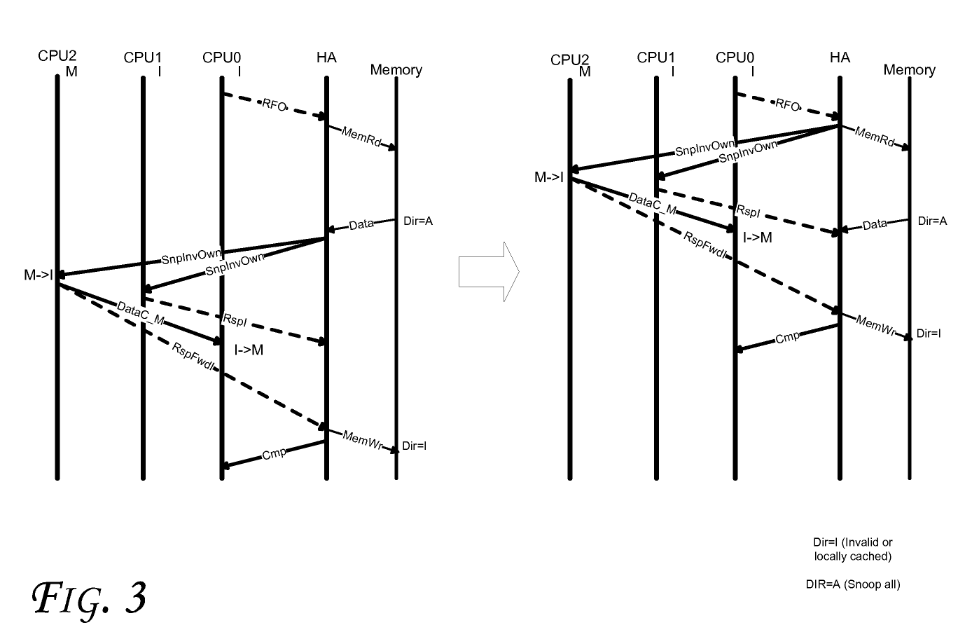

Additionally, at least one of the agents 102 may be a home agent and one or more of the agents 102 may be requesting or caching agents as will be further discussed herein. As shown, at least one agent (only one shown for agent 102-1) may include or have access to one or more logics (or engines) 111 to provide for OSB, as discussed herein, e.g., with reference to FIGS. 3-7. Further, in an embodiment, one or more of the agents 102 (only one shown for agent 102-1) may have access to a memory (which may be dedicated to the agent or shared with other agents) such as memory 120. Also, one or more of the agents 102 (only one shown for agent 102-1) may maintain entries in one or more storage devices (only one shown for agent 102-1, such as directory cache(s) 122, e.g., implemented as a table, queue, buffer, linked list, etc.) to track information about items stored/maintained by the agent 102-1 (as a home agent) and/or other agents (including CAs for example) in the system. In some embodiments, each or at least one of the agents 102 may be coupled to the memory 120 and/or a corresponding directory cache 122 that are either on the same die as the agent or otherwise accessible by the agent.

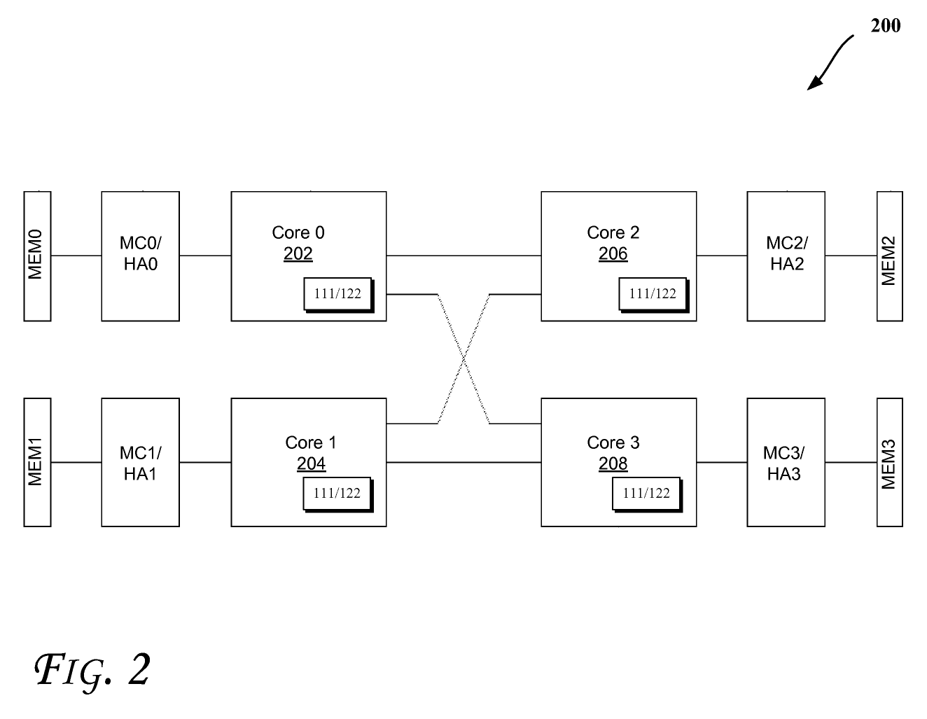

FIG. 2 is a block diagram of a computing system in accordance with an embodiment. System 200 may include a plurality of sockets 202-208 (four shown but some embodiments may have more or less socket). Each socket may include a processor in an embodiment. Also, each socket may be coupled to the other sockets via point-to-point (PtP) link such as discussed with reference FIG. 7. As discussed with respect to FIG. 1 with reference to the network fabric 104, each socket may be coupled to a local portion of system memory, e.g., formed of a plurality of Dual Inline Memory Modules (DIMMs) that may include dynamic random access memory (DRAM).

As shown in FIG. 2, each socket may be coupled to a memory controller (MC)/Home Agent (HA) (such as MC0/HA0 through MC3/HA3). The memory controllers may be coupled to a corresponding local memory (labeled as MEMO through MEM3), which may be a portion of system memory (such as memory 712 of FIG. 7). In some embodiments, the memory controller (MC)/Home Agent (HA) (such as MC0/HA0 through MC3/HA3) may be the same or similar to agent 102-1 of FIG. 1 (e.g., including logic 111, etc.) and the memory, labeled as MEMO through MEM3, may be the same or similar to memory 120 of FIG. 1. Also, in one embodiment, MEMO through MEM3 may be configured to provide for OSB. Also, one or more components of system 200 may be included on the same integrated circuit die in some embodiments.

An implementation such as shown in FIG. 2 thus may be for a socket glueless configuration with mirroring. For example, data assigned to a memory controller (such as MC0/HA0) may be mirrored to another memory controller (such as MC3/HA3) over the PtP links. Also, the directory associated with memory controller MC3/HA3 may initialized in the unknown (U)-state upon a copy to mirror. Upon failover to this controller (e.g., due to an online service-call for this memory controller), the directory may be reconstructed from the U-state.

Operations discussed with reference to FIGS. 3-5 may be performed by components discussed with reference to FIG. 1, 2, 6, or 7. As discussed herein (e.g., with reference to FIGS. 3-5), “CPU” refers to Central Processing Unit, “HA” refers to Home Agent, “M” refers to a modified cache state, “I” refers to an invalid cache state, “E” refers to an exclusive cache state, “RFO” refers to Read For Ownership operation, “MemRd” refers to a memory read operation, “SnpInvOwn” refers to a snoop-and-invalidate-for-ownership transaction, “RspFwdI” refers to response forwarded after invalidating, “MemWr” refers to a memory read operation, “DataC_M” refers to data returned in M state, “Dir” refers to memory directory (such as discussed with reference to FIG. 1), “Cmp” refers to a completion signal, “SnpInvItoE” refers to a snoop to invalidate to E state transaction, “GntE_Cmp” refers to granting E state ownership of cache line without data, “DataC_E_Cmp” refers to a completion signal with DataC_M, and “InvItoE” refers to an invalidate to E state transaction, i.e., a request just for exclusive ownership of the cache line without the data.

More specifically, FIG. 3 illustrates a flow diagram of RFO (Read For Ownership) according to an embodiment. FIG. 3 may be equally applicable for all reads operations though. Moreover, FIG. 3 illustrates a cache-to-cache transfer flow without (on the left side of FIG. 3) vs. with OSB (latency saving—on the right side of FIG. 3) according to an embodiment.

Generally, in a directory based system, the directory information is read from memory first, before snooping (see, e.g., left side of FIG. 3), to determine if snooping of caching agents is needed from the home agent. This sequence minimizes the required coherence interconnect (QPI (Quick Path Interconnect) or ring) bandwidth usage and power consumption, but increases the latency in the cases where snooping is required. To reduce latency (for the cases where we need to snoop), the home agent could start the snoops speculatively as soon as a request enters the home trackers without knowing the directory information (see, e.g., right side of FIG. 3). This will result in extraneous snoops and snoop responses and hence less efficient use of available coherence interconnect bandwidth and higher power. To minimize any negative impact on high interconnect bandwidth applications, the speculative snooping mechanism may be made adaptive in an embodiment. The opportunistic snoops will be sent out of the home agent only under low interconnect bandwidth usage (as determined by logic 111 for example).

In an embodiment, Opportunistic Snoop Broadcast (OSB) uses a logic (e.g., logic 111) which monitors the coherence interconnect bandwidth to adaptively decide whether to send snoops opportunistically. This will in turn provide an early data return mechanism where the data may be returned based on the directory information but before all the opportunistic snoop responses arrive, i.e., to avoid penalties which would otherwise be incurred by late arriving snoop responses (i.e., after memory read) for the case where the directory is clean. As shown in FIG. 3, the Cmp (Completion signal) will still be sent after all snoop responses have arrived, the Cmp signals that all coherency is enforced for that transaction (in some cases this implies that all snoop responses were received, while in other cases one may solely rely on directory information to enforce coherency (e.g. directory=I state)).

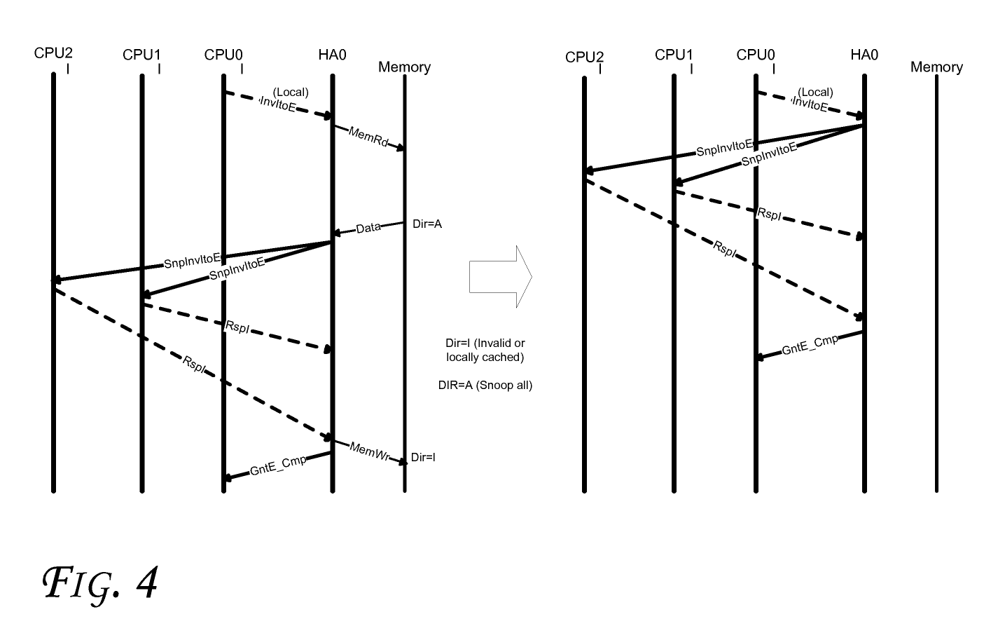

FIG. 4 illustrates a flow diagram of a local InvItoE transaction without (on the left side of FIG. 4) and with OSB (Memory bandwidth savings—on the right side of FIG. 4) according to an embodiment. As shown in FIG. 4, OSB may provide a mechanism (e.g., by specifically allowing controlled snoop broadcasting) to improve application memory bandwidth by eliminating memory lookup and update for some requests that need pure ownership of cache line and no data. The opportunistic/adaptive nature of the snoop broadcast controlled by coherence interconnect bandwidth allows this optimization to be extended to large systems without impact to system performance and bandwidth when snoops are not necessary. In this embodiment, the InvItoE request originates from a caching agent which is not tracked in the directory state, hence no directory update is required.

As shown in FIG. 4, an embodiment stops the read from occurring to memory for local InvItoE and instead broadcast snoops (trading-off interconnect bandwidth for memory bandwidth) in an adaptive manner such that the interconnect bandwidth always remains within the limits to not negatively impact system performance or application bandwidth. On the contrary, traditional systems with directory mode enabled, do not issue any speculative snoops to caching agents covered by directory.

In the traditional directory mode, (e.g., QPI) InvItoE transactions will read the memory directory to determine if snooping is needed. In this situation, the memory read is completely unnecessary since no data is returned to the requestor if the home agent had speculatively issued snoops and can determine that a directory update is not necessary. In specific directory based systems where the local caching agent is not under directory control, it is possible to completely eliminate directory lookup and update for local InvItoE transactions with an embodiment of the invention. The unconditional snooping of the local caching agent, and always waiting for local snoop response before sending a response to the requestor, will guarantee that coherence is always maintained.

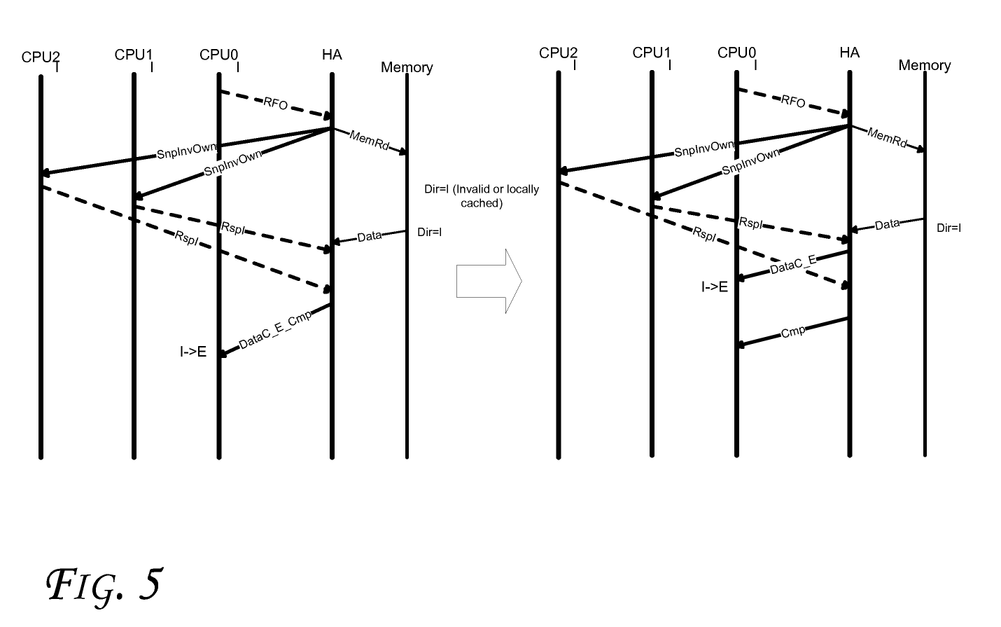

FIG. 5 illustrates a flow diagram of transaction flow without (on the left side of FIG. 5) and with Early Data Return (EDR) (on the right side of FIG. 5). Moreover, since OSB may speculatively issue snoops, it is possible that snoops are broadcast for accesses that would find the directory in a state which can return data directly from memory. In this case, if snoops have been issued, the home agent will traditionally wait to collect all the snoop responses before sending data and complete to the requestor. This could potentially increase the latency for clean memory accesses, if the snoop latency is longer than memory latency. To avoid this negative impact, OSB may also implement an early data return policy (as shown in FIG. 5). The early data return policy will allow data to return to the requestor before all the snoop responses are collected if the directory state is clean (or more generally, when the directory indicates that no cache-to-cache forwarding can happen). The final complete will however be returned only upon collecting all snoop responses in an embodiment.

In an embodiment, OSB provides a mechanism to monitor the interconnect bandwidth to determine whether to send snoops opportunistically. For example, the home agent (e.g., via logic 111) may monitor the interconnect (e.g., QPI) credits as a proxy for bandwidth of links, and egress occupancy as a proxy for ring bandwidth. In one embodiment, programmable thresholds with associated counters or measure trackers may allow for tuning and control of OSB based on one or more measurements of: type of data request, application behavior, and system configuration. For example, the success rate of forwarding (i.e., sharing of data), could dictate different thresholds. One or more counters (e.g., in or accessible by logic 111) may be used to determine success rate of forwarding.

Furthermore, not all transactions are similar in their benefit from snoop broadcast. Specifically, for local InvItoE (such as discussed with reference to FIG. 4, or more generally for InvItoE from a CA not tracked in the directory or an address not tracked in the directory), there is not even a functional need to update the directory in memory. Hence, there is no need to read the background data, nor read the directory from memory if snoops are broadcast. For local streaming full-cacheline-writes, which follow an interconnect (e.g., QPI) flow of InvItoE followed by an explicit write-back, this will reduce the number of memory reads, resulting in better application bandwidth. Broadcasting snoops for local InvItoE transactions may result in significant boost in application bandwidth. However, unconditionally broadcasting snoop for all transactions could result in transactions other than local InvItoE occupying all the opportunities for snoop broadcast. Hence, OSB provides a memory bandwidth benefit in some embodiments.

Generally, applications that tend to share cache lines and need snoops to complete transactions might be more likely to have remote transactions needing snoops than local transactions. For example, benchmarks like TPC-C tend to have more cache-to-cache transfers on remote accesses. But these applications tend to operate at low to medium bandwidth levels. In an embodiment, OSB may provide a latency advantage because of early cache-to-cache forwarding (before the directory information returns from memory) on remote read transactions.

To accommodate and take advantage of these specific application characteristics, in various embodiments, OSB may distinguish: (i) remote Rd+InvItoE traffic, (ii) local Rd traffic, and (iii) local InvItoE traffic. Separate and programmable thresholds to gauge coherence interconnect bandwidth for each distinguished traffic type may be implemented to allow for better control and tuning of the opportunistic snoops issued. It is possible to distinguish even more transaction types if necessary and change these thresholds dynamically.

To address the power implications in accordance with some embodiments, OSB may provide a mechanism to dynamically change interconnect bandwidth thresholds, or just turn off OSB, based on application access patterns or based on a higher level entity (PCU (Power Control Unit), BIOS (Basic Input/Output System), OS (Operating System)) which might decide to operate in a more power efficient mode than just chase pure performance. For example, to deal with the application access patterns, simple heuristics that track the ratio of requests needing snoops vs. the total number of directory lookups may be used to turn off OSB when no hits (for requests needing snoops) are found in a (programmable) window. OSB may be turned back on when the number of hits reach another programmable threshold. This enables one to turn off OSB while running 100% NUMA applications for instance. Another example is where BIOS or the OS is aware that the system needs to operate power efficiently and this could switch off OSB.

FIG. 6 illustrates a block diagram of an embodiment of a computing system 600. One or more of the agents 102 of FIG. 1 may comprise one or more components of the computing system 600. Also, various components of the system 600 may include a directory cache (e.g., such as directory cache 122 of FIG. 1) and/or a logic (such as logic 111 of FIG. 1) as illustrated in FIG. 6. However, the directory cache and/or logic may be provided in locations throughout the system 600, including or excluding those illustrated. The computing system 600 may include one or more central processing unit(s) (CPUs) 602 (which may be collectively referred to herein as “processors 602” or more generically “processor 602”) coupled to an interconnection network (or bus) 604. The processors 602 may be any type of processor such as a general purpose processor, a network processor (which may process data communicated over a computer network 605), etc. (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors.

The processor 602 may include one or more caches (e.g., other than the illustrated directory cache 122), which may be private and/or shared in various embodiments. Generally, a cache stores data corresponding to original data stored elsewhere or computed earlier. To reduce memory access latency, once data is stored in a cache, future use may be made by accessing a cached copy rather than refetching or recomputing the original data. The cache(s) may be any type of cache, such a level 1 (L1) cache, a level 2 (L2) cache, a level 3 (L3), a mid-level cache, a last level cache (LLC), etc. to store electronic data (e.g., including instructions) that is utilized by one or more components of the system 600. Additionally, such cache(s) may be located in various locations (e.g., inside other components to the computing systems discussed herein, including systems of FIG. 1, 2, 6, or 7).

A chipset 606 may additionally be coupled to the interconnection network 604. Further, the chipset 606 may include a graphics memory control hub (GMCH) 608. The GMCH 608 may include a memory controller 610 that is coupled to a memory 612. The memory 612 may store data, e.g., including sequences of instructions that are executed by the processor 602, or any other device in communication with components of the computing system 600. Also, in one embodiment of the invention, the memory 612 may include one or more volatile storage (or memory) devices such as random access memory (RAM), dynamic RAM (DRAM), synchronous DRAM (SDRAM), static RAM (SRAM), etc. Nonvolatile memory may also be utilized such as a hard disk. Additional devices may be coupled to the interconnection network 604, such as multiple processors and/or multiple system memories.

The GMCH 608 may further include a graphics interface 614 coupled to a display device 616 (e.g., via a graphics accelerator in an embodiment). In one embodiment, the graphics interface 614 may be coupled to the display device 616 via an accelerated graphics port (AGP). In an embodiment of the invention, the display device 616 (such as a flat panel display) may be coupled to the graphics interface 614 through, for example, a signal converter that translates a digital representation of an image stored in a storage device such as video memory or system memory (e.g., memory 612) into display signals that are interpreted and displayed by the display 616.

As shown in FIG. 6, a hub interface 618 may couple the GMCH 608 to an input/output control hub (ICH) 620. The ICH 620 may provide an interface to input/output (I/O) devices coupled to the computing system 600. The ICH 620 may be coupled to a bus 622 through a peripheral bridge (or controller) 624, such as a peripheral component interconnect (PCI) bridge that may be compliant with the PCIe specification, a universal serial bus (USB) controller, etc. The bridge 624 may provide a data path between the processor 602 and peripheral devices. Other types of topologies may be utilized. Also, multiple buses may be coupled to the ICH 620, e.g., through multiple bridges or controllers. Further, the bus 622 may comprise other types and configurations of bus systems. Moreover, other peripherals coupled to the ICH 620 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), etc.

The bus 622 may be coupled to an audio device 626, one or more disk drive(s) 628, and a network adapter 630 (which may be a NIC in an embodiment). In one embodiment, the network adapter 630 or other devices coupled to the bus 622 may communicate with the chipset 606. Also, various components (such as the network adapter 630) may be coupled to the GMCH 608 in some embodiments of the invention. In addition, the processor 602 and the GMCH 608 may be combined to form a single chip. In an embodiment, the memory controller 610 may be provided in one or more of the CPUs 602. Further, in an embodiment, GMCH 608 and ICH 620 may be combined into a Peripheral Control Hub (PCH).

Additionally, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media capable of storing electronic data (e.g., including instructions).

The memory 612 may include one or more of the following in an embodiment: an operating system (O/S) 632, application 634, directory 601, and/or device driver 636. The memory 612 may also include regions dedicated to Memory Mapped I/O (MMIO) operations. Programs and/or data stored in the memory 612 may be swapped into the disk drive 628 as part of memory management operations. The application(s) 634 may execute (e.g., on the processor(s) 602) to communicate one or more packets with one or more computing devices coupled to the network 605. In an embodiment, a packet may be a sequence of one or more symbols and/or values that may be encoded by one or more electrical signals transmitted from at least one sender to at least on receiver (e.g., over a network such as the network 605). For example, each packet may have a header that includes various information which may be utilized in routing and/or processing the packet, such as a source address, a destination address, packet type, etc. Each packet may also have a payload that includes the raw data (or content) the packet is transferring between various computing devices over a computer network (such as the network 605).

In an embodiment, the application 634 may utilize the O/S 632 to communicate with various components of the system 600, e.g., through the device driver 636. Hence, the device driver 636 may include network adapter 630 specific commands to provide a communication interface between the O/S 632 and the network adapter 630, or other I/O devices coupled to the system 600, e.g., via the chipset 606.

In an embodiment, the O/S 632 may include a network protocol stack. A protocol stack generally refers to a set of procedures or programs that may be executed to process packets sent over a network 605, where the packets may conform to a specified protocol. For example, TCP/IP (Transport Control Protocol/Internet Protocol) packets may be processed using a TCP/IP stack. The device driver 636 may indicate the buffers in the memory 612 that are to be processed, e.g., via the protocol stack.

The network 605 may include any type of computer network. The network adapter 630 may further include a direct memory access (DMA) engine, which writes packets to buffers (e.g., stored in the memory 612) assigned to available descriptors (e.g., stored in the memory 612) to transmit and/or receive data over the network 605. Additionally, the network adapter 630 may include a network adapter controller, which may include logic (such as one or more programmable processors) to perform adapter related operations. In an embodiment, the adapter controller may be a MAC (media access control) component. The network adapter 630 may further include a memory, such as any type of volatile/nonvolatile memory (e.g., including one or more cache(s) and/or other memory types discussed with reference to memory 612).

FIG. 7 illustrates a computing system 700 that is arranged in a point-to-point (PtP) configuration, according to an embodiment of the invention. In particular, FIG. 7 shows a system where processors, memory, and input/output devices are interconnected by a number of point-to-point interfaces. The operations discussed with reference to FIGS. 1-6 may be performed by one or more components of the system 700.

As illustrated in FIG. 7, the system 700 may include several processors, of which only two, processors 702 and 704 are shown for clarity. The processors 702 and 704 may each include a local memory controller hub (GMCH) 706 and 708 to enable communication with memories 710 and 712. The memories 710 and/or 712 may store various data such as those discussed with reference to the memory 712 of FIG. 7. As shown in FIG. 7, the processors 702 and 704 (or other components of system 700 such as chipset 720, I/O devices 743, etc.) may also include one or more cache(s) such as those discussed with reference to FIGS. 1-8.

In an embodiment, the processors 702 and 704 may be one of the processors 702 discussed with reference to FIG. 7. The processors 702 and 704 may exchange data via a point-to-point (PtP) interface 714 using PtP interface circuits 716 and 718, respectively. Also, the processors 702 and 704 may each exchange data with a chipset 720 via individual PtP interfaces 722 and 724 using point-to-point interface circuits 726, 728, 730, and 732. The chipset 720 may further exchange data with a high-performance graphics circuit 734 via a high-performance graphics interface 736, e.g., using a PtP interface circuit 737.

In at least one embodiment, a directory cache and/or logic may be provided in one or more of the processors 702, 704 and/or chipset 720. Other embodiments of the invention, however, may exist in other circuits, logic units, or devices within the system 700 of FIG. 7. Furthermore, other embodiments of the invention may be distributed throughout several circuits, logic units, or devices illustrated in FIG. 7. For example, various components of the system 700 may include a directory cache (e.g., such as directory cache 122 of FIG. 1) and/or a logic (such as logic 111 of FIG. 1). However, the directory cache and/or logic may be provided in locations throughout the system 700, including or excluding those illustrated.

The chipset 720 may communicate with the bus 740 using a PtP interface circuit 741. The bus 740 may have one or more devices that communicate with it, such as a bus bridge 742 and I/O devices 743. Via a bus 744, the bus bridge 742 may communicate with other devices such as a keyboard/mouse 745, communication devices 746 (such as modems, network interface devices, or other communication devices that may communicate with the computer network 705), audio I/O device, and/or a data storage device 748. The data storage device 748 may store code 749 that may be executed by the processors 702 and/or 704.

In various embodiments of the invention, the operations discussed herein, e.g., with reference to FIGS. 1-7, may be implemented as hardware (e.g., circuitry), software, firmware, microcode, or combinations thereof, which may be provided as a computer program product, e.g., including a (e.g., non-transitory) machine-readable or (e.g., non-transitory) computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed with respect to FIGS. 1-7. Additionally, such computer-readable media may be downloaded as a computer program product, wherein the program may be transferred from a remote computer (e.g., a server) to a requesting computer (e.g., a client) through data signals in a carrier wave or other propagation medium via a communication link (e.g., a bus, a modem, or a network connection).

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
a first agent to receive a request for data from a second agent via a link; and
logic to cause broadcast of a plurality of snoops to a plurality of caching agents in response to the request for data and based on a comparison of a bandwidth consumption of the link and a threshold value.

2. The apparatus of claim 1, wherein the logic is to cause broadcast of the plurality of snoops to the plurality of caching agents in response to the request for data and based on the comparison of the bandwidth consumption of the link and the threshold value for one or more select transaction types.

3. The apparatus of claim 1, wherein the first agent is to return the data before all responses to the plurality of snoops are collected and based on stored information that indicates no cache-to-cache forwarding can happen.

4. The apparatus of claim 1, further comprising a memory coupled to the first agent, wherein the first agent is to access data in the memory.

5. The apparatus of claim 1, wherein the first agent and the second agent are to maintain a directory, the directory to store information about at which agent and in what state each cache line is cached.

6. The apparatus of claim 1, wherein the first agent is to comprise the first logic.

7. The apparatus of claim 1, further comprising a memory directory, coupled to the first agent, to store data corresponding to a plurality of caching agents coupled to the first agent, wherein some caching agents or cache lines are not under a control of the memory directory and wherein requests from caching agents not under the control of the memory directory and invoking opportunistic snoop broadcast, do not need to read the memory directory.

8. The apparatus of claim 7, wherein the first agent is to update the memory directory in response to one or more snoop responses received from one or more of the plurality of caching agents.

9. The apparatus of claim 1, wherein the logic is to monitor credits associated with the link as a proxy for the bandwidth consumption and egress occupancy as a proxy for ring bandwidth.

10. The apparatus of claim 1, wherein the logic is to allow for tuning and control of broadcast of the plurality of snoops based on one or more of: a type of the data request, application behavior, and system configuration.

11. The apparatus of claim 1, wherein the first agent and the second agent are on a same integrated circuit die.

12. The apparatus of claim 1, wherein the link is to comprise a point-to-point interconnect.

13. The apparatus of claim 1, wherein one or more of the first agent or the second agent are to comprise a plurality of processor cores.

14. The apparatus of claim 1, wherein one or more of the first agent or the second agent are to comprise a plurality of sockets.

15. A method comprising:
receiving at a first agent a request for data from a second agent via a link; and
causing broadcast of a plurality of snoops to a plurality of caching agents in response to the request for data and based on a comparison of a bandwidth consumption of the link and a threshold value.

16. The method of claim 15, further comprising causing broadcast of the plurality of snoops to the plurality of caching agents in response to the request for data and based on the comparison of the bandwidth consumption of the link and the threshold value for one or more select transaction types.

17. The method of claim 15, further comprising returning the data before all responses to the plurality of snoops are collected and based on stored information that indicates no cache-to-cache forwarding can happen.

18. The method of claim 15, further comprising the first agent accessing data in a memory in response to the data request.

19. The method of claim 15, further comprising maintaining a directory to store information about at which agent and in what state each cache line is cached.

20. The method of claim 15, further comprising storing data, corresponding to a plurality of caching agents, in a memory directory.

21. The method of claim 21, further comprising updating the memory directory in response to one or more snoop responses received from one or more of the plurality of caching agents.

22. The method of claim 15, further comprising monitoring credits associated with the link as a proxy for the bandwidth consumption and egress occupancy as a proxy for ring bandwidth.

23. The method of claim 15, further comprising tuning and controlling broadcast of the plurality of snoops based on one or more of: a type of the data request, application behavior, and system configuration.

24. A system comprising:
a memory to store a directory, the directory to store information about at which agent and in what state each cache line is cached; and
a first agent to receive a request for data from a second agent via a link; and
logic to cause broadcast of a plurality of snoops to a plurality of caching agents in response to the request for data and based on a comparison of a bandwidth consumption of the link and a threshold value.

25. The system of claim 24, wherein the logic is to cause broadcast of the plurality of snoops to the plurality of caching agents in response to the request for data and based on the comparison of the bandwidth consumption of the link and the threshold value for one or more select transaction types.

26. The system of claim 24, wherein the first agent is to return the data before all responses to the plurality of snoops are collected and based on stored information that indicates no cache-to-cache forwarding can happen.

27. The system of claim 24, wherein the first agent is to update the directory in response to one or more snoop responses received from one or more of the plurality of caching agents.

28. The system of claim 24, wherein the logic is to monitor credits associated with the link as a proxy for the bandwidth consumption and egress occupancy as a proxy for ring bandwidth.

29. The system of claim 24, wherein the logic is to allow for tuning and control of broadcast of the plurality of snoops based on one or more of: a type of the data request, application behavior, and system configuration.

30. The system of claim 24, wherein the first agent and the second agent are on a same integrated circuit die.
